(19) United States
(12) Patent Application Publication
(10) Pub. No.: US 2011/0169217 A1
(43) Pub. Date: Jul. 14, 2011

(54) Method and Device for Transporting Paper Within a Paper Handling Installation from a First Conveyor to a Second Conveyor

(76) Inventors: Manfred Ziegler, Augsburg (DE); Helmut Koelle, Augsburg (DE); Walter Okelmann, Augsburg (DE); Andreas Glossner, Mering (DE); Helmut Eichelberg, Buttenwiesen (DE); Christian Keil, Oberottmarshausen (DE)

(21) Appl. No.: 12/865,091

(22) PCT Filed: Dec. 23, 2008
(86) PCT No.: PCT/EP2008/011062

§ 371 Date: Nov. 19, 2010

(30) Foreign Application Priority Data
Jan. 29, 2008 (DE) 10 2008 006 562.5

(51) Int. Cl. B65H 29/12; B65G 39/00; B65G 43/00

(52) U.S. Cl. 271/278; 198/339.1; 198/341.01; 83/13; 83/109

(57) ABSTRACT

In a method and a device for transporting paper within a paper handling installation from a first conveyor to a second conveyor, the second conveyor has a velocity which at least partially follows a drive curve of the first conveyor. A frictional force between the second conveyor and the paper is set to a first value when the first conveyor and the second conveyor are in engagement with the paper. The frictional force between the second conveyor and the paper is set to a second value, which is higher than the first value, when the papers is conveyed by the second conveyor.

### CROSS-REFERENCE TO RELATED APPLICATION

This application is a U.S. National Phase entry of PCT/EP2008/011062 filed Dec. 23, 2008, and claims priority to German Patent Application No. 102008006562.5-27 filed Jan. 29, 2008, each of which is incorporated herein by references hereto.

### BACKGROUND OF THE INVENTION

Embodiments of the invention relate to a method and a device for transporting paper within a paper handling installation from a first conveyor, or first transport, to a second conveyor, or second transport, e.g. to a cutter cutting a paper web into individual sheets and forwarding it to a point of entry of a subsequent processing station.

In conventional technology, paper handling installations are known which receive individual goods, for example personalized cover letters or sheets, collate them into groups consisting of a plurality of individual goods, and process them further for shipping. Such groups comprise, for example, a cover letter to a receiver and possibly one or several follow-up pages of the letter as well as the objects associated with the letter, such as credit cards or the like. Additionally, the group may comprise supplements, or inserts. The group collated is then prepared for shipping, for example by folding the group and sealing the edges of the folded group, or by enveloping the collated groups.

Such an installation receives the sheets to be processed via one or several input channels, it being possible for such an input channel to be configured such that a paper web printed on by an upstream printer is fed in. Such paper webs may be printed in a one-up or two-up manner. When supplying webs that are thus prepared, a cross-section is performed in the input channel to produce individual sheets. If the webs are printed on in a multi-up manner, one or several longitudinal sections are performed prior to the cross-section.

FIG. 1 shows a schematic representation of a known paper handling installation. The paper handling installation shown is an enveloping installation 100 and comprises a first input 102 and a second input 104, each of which is provided with a continuous web 106 and 108, respectively. The paper web 106 provided to the first input 102 is printed on in a one-up manner, and the paper web 108 provided to the second input 104 is printed on in a two-up manner. The inputs 102 and 104 comprise cutters 110 and 112 so as to transversely cut the paper webs 106 and 108 supplied so as to produce the individual sheets to be processed. In addition, the paper web 108 printed upon in a two-up manner is longitudinally cut. By means of further modules, indicated schematically in FIG. 1 by arrows 114 and 116, the cut sheets are provided individually or in groups to an enveloper 118, which envelopes them.

The paper handling installation described above consists of various components and functional units. In the transition from one functional unit to the next, there are conveyors which convey the paper from one component to the next. Advantageously, the paper is transported such that it is clamped in, at the point of exit of the first component, and is taken over, at the point of entry of the subsequent component, in a dragging, or rubbing, manner at a slight excess velocity. This implementation between components or functional units is unproblematic as long as the paper is not or only very slightly accelerated.

The situation is different for components wherein a sheet is output by a precursor component and is forwarded within the subsequent component at a high level of acceleration. By way of example, consideration shall be given to the situation of the above-described cutting machine, which is running in a start-stop operation. After this, the problem shall be described with reference to a cutting machine, which is to be seen as an example for other components or functional units.

FIG. 2 schematically shows a cutting machine 110 as has been used in conventional technology in paper handling systems of the type described by means of FIG. 1. FIG. 2(A) depicts a schematic representation of a known paper cutting machine 110. The cutting machine 110 comprises a paper feeding means (first conveyor) 130 driven by a motor 130a. As may be seen in FIG. 2(A), the paper feeding means 130 comprises a drive roller 132, driven by the motor 130a at a velocity V1, and a guide roller 134. A paper web 140 is fed from a supply region (not shown) (e.g. a roller or a stack) to the paper feeding means 130. By means of the paper feeding means 130, the paper web 140 is fed to a cutting means 144. The cutting means 144 comprises a so-called falling knife 146, which essentially has the shape of a guillotine, and a counter-knife 152, which the falling knife 146 passes, during its cutting motion, in the direction perpendicular to the paper web 140. The falling knife 146 is actuated by a motor 154. When the motor 154 is driven, the falling knife performs a continuous upward and downward motion. Downstream from the cutting means 144, in the paper running direction, a paper discharge means (second conveyor) 164 is provided which serves to forward the cut pieces of paper. Said paper discharge means comprises a drive roller 168 actuated by a motor 166. The motor 166 drives the drive roller 168 at a constant velocity V3. Generally, the velocity V3 of the drive roller 168 is higher than the feeding velocity of the paper web 140, so that reliable removal of the cut papers is ensured. The paper discharge means 164 comprises a guide roller 170 in addition to the drive roller 168, the cut papers moving between the drive roller 168 and the guide roller 170.

With regard to the diagrams depicted in FIG. 2(B), the fundamental operation of the cutting machine described in FIG. 2(A) will be explained in more detail below. At a time t=0, the motor 130a is driven so as to drive the feeding means 130, so that the paper is accelerated to have a velocity V1. At the time t₁, the predetermined velocity V1 is achieved and is maintained up to the time t₂. When the time t₂ is reached, a position of the paper web 140 at which cutting is to be performed is already close to the cutting means 144. The drive of the feeding means is controlled such that from the time t₂, the paper web 140 is slowed down, so that it is stopped at the time t₃. As soon as the time t₃ is reached, the motor 154 is driven and accelerated to the velocity V2, which is reached by the time t₄. This velocity is maintained until the time t₅, and by the time t₆, the velocity is reduced to zero. During the time period from t₃ to t₆, the falling knife 146 performs a cutting motion, and the paper web 140 is cut at the desired position. The paper discharge means 164, continuously driven by the motor 168 at the velocity V3, ensures that the paper cut is transported further. As soon as the time t₆ is reached, the control of the velocities, which is described by means of FIG. 2(B), starts again, and the paper web 140 continues to be fed in the direction of the cutting device 144 until the corresponding cutting position on the paper web 140 is reached. Such cutters are described, e.g., in WO 97/11902 A1, WO 96/33122 A1 and in WO 01/66448 A2.

The start-stop operation of a cutting machine means that the paper is stopped when the cut is made. Here, a dragging conveyor is used for removing the paper, said removal being conducted at a constant output velocity that is higher than the advance drive (see FIG. 2). The excess velocity may be used in order to quickly continue transporting the paper, on the one hand, and to pull the paper web tight for the cut, on the other hand, so that any cross folds in the paper do not cause a large variance in the cutting lengths. With such a dragging conveyor, the velocity, which is constant, but higher than the advance drive, leads to a large difference in velocities between the paper that is not moved during cutting and the elements of the dragging conveyor. This large difference in velocity and the essentially constant pressure exerted upon the paper by the conveyor, or transport, elements leads to generation of energy (e.g. heat energy, frictional energy) applied to the paper. If the paper is kept within the dragging conveyor over a long period of time, the imprint on the paper (the printing applied to the paper by a printer) may be damaged. Typically, digital printers are used which employ a toner for printing. The toner may be fused between the rollers due to the arising frictional heat, and may be transferred onto the rollers. However, the toner is transferred back to the paper from the rollers, which may lead to stripes and speckles on the paper, such contamination of the paper being undesired.

The problem that has just been described is exacerbated when the cycle time of the cutting machines discussed in FIG. 2 is to be increased even further. This is implemented by increasing the velocities and the accelerations at which the paper is advanced. This results in that the cut sheet may also be removed by the dragging conveyer at a higher velocity and acceleration in order to make way for the next advancement. This causes an increase in the abovementioned difference in velocities and, thus, to an increase in the energy introduced into the paper.

One possible solution is to implement the removal such that one of the conveyor elements, e.g. a bottom roller, is in contact with the paper and runs at a constant velocity so as to realize the dragging transport during positioning and cutting, whereas a further conveyor element, e.g. an upper roller, is lifted off and is put down only for removing the cut paper. By this putting down, the pressure exerted on the paper is highly increased, and the arising slip results in the abovementioned difference in velocity. This difference in velocity, or relative motion, between the paper and the upper roller provides the frictional heat causing the damage. For very sensitive toners, a transferal of toner if effected by the constantly running roller (e.g. the bottom roller) without any further application of force even when the pinch roller (e.g. upper roller) is lifted off.

A further possible solution would be to provide a controlled drive wherein the conveyor elements of the removal system are in engagement with the paper, so that the paper is taken over without any slip (with a very high pressure force). In this case, there is the problem that a pressure set too high ensures a high level of reliability for removing the cut sheet, but the advancement within the cutting machine is adversely affected by the high additional force, so that the advance drive can no longer position the paper in the correct cutting position within the tight tolerances. This problem also occurs if the rollers are lifted off during clocked transport.

However, the above problems do not occur only for the cutters described. Rather, such problems arise wherever transport of a paper is handed over from a first conveyor to a second conveyor within a paper handling installation.

U.S. Pat. No. 4,429,602 A describes a device for cutting material webs which operates in a start-stop operation and wherein two pairs of rollers are provided upstream from a cutter, the first pair of rollers continuously driving the web of material. A stopping element effects the start-stop operation. During the cutting, the second pair of rollers exerts a lower pressure on the web of material.

DE 25 12 540 A describes a cutter for cutting a paper web wherein the distance to be covered between the cutter and the output rollers is reduced during the cut.

DE 35 21 324 C2 describes a device for slowing down a web of paper within a photocopier prior to putting it down on an output plate. The paper web passes two successive pairs of rollers, the trailing pair of rollers slowing down the web when said web is released by the leading pair of rollers.

U.S. Pat. No. 5,678,817 A and DE 699 18 206 T2 describe devices for singulating sheets.

### SUMMARY

According to an embodiment, a method of transporting printed paper within a paper handling installation from a first conveyor to a second conveyor, wherein the second conveyor has a velocity which at least partially follows a drive curve of the first conveyor when the paper is conveyed by the first conveyor and the second conveyor, may have the steps of: conveying the paper by the first conveyor in the direction of the second conveyor; once the paper has reached the second conveyor, conveying the paper by the first conveyor and the second conveyor, wherein a frictional force between the second conveyor and the paper is set to a first value; processing the paper; and conveying the processed paper by the second conveyor, wherein the frictional force between the second conveyor and the paper is set to a second value, which is higher than the first value.

According to another embodiment, a paper handling installation may have: a first conveyor and a second conveyor, the second conveyor having a velocity which at least partially follows a drive curve of the first conveyor when the paper is conveyed by the first conveyor and the second conveyor; a processor for processing the paper; and a controller operatively connected to the first conveyor, the second conveyor and the processor for processing the paper so as to result in that the paper is conveyed by the first conveyor in the direction of the second conveyor; once the paper has reached the second conveyor, the paper is conveyed by the first conveyor and the second conveyor, conveying the paper by the first conveyor and the second conveyor, a frictional force between the second conveyor and the paper being set to a first value; the paper is processed by the processor; and the processed paper is conveyed by the second conveyor, the frictional force between the second conveyor and the paper being set to a second value higher than the first value.

### BRIEF DESCRIPTION OF THE DRAWINGS

Embodiments of the present invention will be detailed subsequently referring to the appended drawings, in which:

FIG. 1 shows a schematic representation of a paper handling installation wherein cutters may be employed in accordance with embodiments of the invention;

FIG. 2 shows a schematic representation of a known cutter (FIG. 2(A), and the velocity profiles of paper-web feeding and of a cutting element (FIG. 2(B);

FIGS. 3(A) to (D) show schematic representations of a device for transporting paper from a first conveyor to a second conveyor within a paper handling installation, by means of which the functionality of embodiments of the invention shall be explained;

FIG. 4 shows a schematic representation of a device for taking over sheets from a cutter in accordance with embodiments of the invention;

FIG. 5 shows the time curve of the velocities of the inlet means of the cutter and the outlet means (velocity profiles) and of the pressure, exerted on a sheet by the outlet means, in accordance with embodiments of the invention; and

FIG. 6 shows the time curve of the velocities of the inlet means of the cutter and the outlet means and of the pressure, exerted on a sheet by the outlet means, in accordance with further embodiments of the invention.

### DETAILED DESCRIPTION OF THE INVENTION

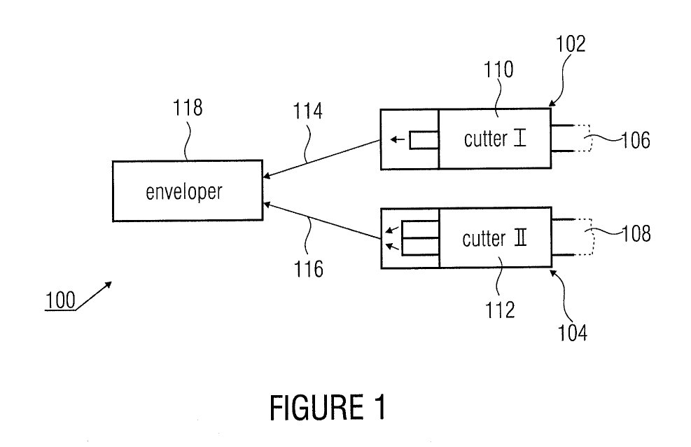

Embodiments of the invention, for example cutters in accordance with embodiments of the invention, may be employed, e.g., in the paper handling installation shown in FIG. 1.

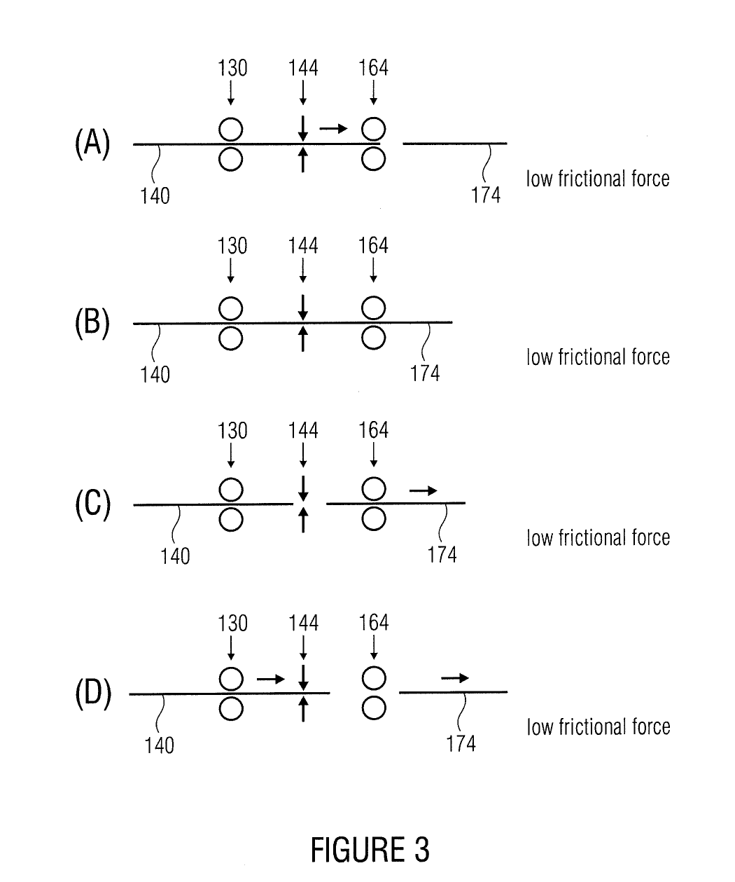

FIG. 3 shows schematic representations of a device for transporting paper from a first conveyor to a second conveyor which serve to provide a more detailed description of embodiments of the present invention below.

Using the example of a cutter, FIG. 3 shows a situation wherein a paper web 140 is introduced between the conveyors 130 and 164, i.e. a situation immediately prior to cutting. In addition, FIG. 3(A) shows the sheet 174 that was already cut in the preceding cycle. In accordance with embodiments of the invention, the conveyor 164 is configured such that it has a velocity which at least partially follows a drive curve of the first conveyor 130, in particular in a situation, shown in FIG. 3(A), wherein the paper web 140 is conveyed both by the first conveyor 130 and by the second conveyor 164. To avoid the above-described problems, a frictional force between the second conveyor 164 and the paper web 140 is set, in accordance with embodiments of the invention, to a first, low value, whereby potential toner abrasion is avoided while ensuring that the paper web 140 is also conveyed by the conveyor 164, so that said paper web 140 is pulled tight, for example, for cutting so as to avoid any problems with regard to a cutting position. The frictional force is dependent on a coefficient of friction of the article to be conveyed and of the conveyor elements and/or the pressure exerted by the conveyor elements on the article to be conveyed.

FIG. 3(B) shows a situation similar to that of FIG. 3(A), in this case, however, the paper web 140 having been conveyed to such a point that the cutting position has been reached. In this situation, the transport rollers of the conveyor 130 are stopped, but the transport rollers of the conveyor 164 continue to be driven so as to keep the paper web tight. In this situation, too, the frictional force between the conveyor 164 and the paper web 140, or the sheet 174 to be cut, remains at the low level so as to avoid any problems regarding toner abrasion. It shall be noted here that in the situations shown in FIGS. 3(A) and 3(B), the frictional force may be set to a shared frictional force or to different frictional forces, respectively.

FIG. 3(C) shows the situation directly after cutting. The conveyor 130 is still stopped, and the conveyor 164 is driven at increased velocity so as to quickly discharge the individual sheet 174 that has been cut. In this situation, the frictional force between the conveyor elements of the conveyor 164 and the cut sheet 174 is set to a higher value. Advantageously, the frictional force between the second conveyor and the paper is set to a second value, which is higher than the first value, when the paper is conveyed only by the second conveyor.

FIG. 3(D) shows a situation wherein the cut sheet 174 has already left the second conveyor 164 and the paper web 140 is moved along in the direction of the second conveyor, in this situation the second conveyor 164 advantageously being set such that a frictional force between the conveyor and the paper web 140 to be received is reset to the first, lower value.

Using FIG. 3, the idea underlying the present invention was described by means of a cutter. Similar problems as were illustrated above may also occur, however, during transfer of individual sheets or papers from a first conveyor 130 to a second conveyor 164, in particular during a dragging transfer, when the second conveyor 164 operates at a higher velocity than the first conveyor 130. In such a situation, in FIG. 3(A), a first individual sheet would then be moved along by the conveyor 130 in the direction of the conveyor 164; in this situation, the frictional force caused by the conveyor 164 would be set to a low value, given the imminent reception of the sheet. In a situation as is shown in FIG. 3(B), the sheet would be conveyed by both conveyors 130 and 164 for a short period of time, in which case problems as were described above are avoided because the frictional force between the sheet and the conveyor 164 has been set to be low. To complete the transfer or transport of the paper from the first conveyor to the second conveyor, provision may be made for the first conveyor 130 to release the sheet so that further transport is exclusively effected by the second conveyor, the frictional force being set to the high value in such a situation.

Embodiments of the invention as were described above set the frictional force between a first, low value and a second, higher value. The transition between the first value and the second value, and also the transition back to the first value, may be effected either step-by-step, in one step or in several steps, or continuously, e.g. in a linearly or exponentially ascending/descending manner. The first value and the second value of the frictional force and, likewise, the step size or the degree of the continual change (e.g. slope of a linear rise) are set in dependence on one or several properties of the paper to be transported and/or in dependence on a velocity at which the paper is conveyed. Properties of the paper in dependence on which the frictional force may be set may be, for example, the mass of the paper, the surface roughness of the paper, the thickness of the paper, the dimension of the paper, or the like. Likewise, the frictional force may be set in dependence on how the paper to be transported was printed upon, with properties of the printing material used, for example of the toner, and of the method of applying the printing material being taken into account.

By means of FIG. 3, embodiments were described wherein the frictional force arising between the conveyor 164 and the sheet 174 is changed between a low value and a high value. In FIG. 3, mention was generally made of a conveyor 164 having such a property, it being possible for such a change in the frictional force caused by the conveyor 164 to be obtained by various implementations of the conveyor. Embodiments of the invention relate to conveyors wherein the elements of the conveyor 164 are controlled to set the frictional force between the elements and the paper to be conveyed by changing the pressure exerted on the paper by the elements of the conveyor 164. As was mentioned above, such a change in the frictional force/pressure may be effected step-by-step or continuously; for example, starting from a situation where no pressure at all is exerted, a final, maximally admissible pressure may be continuously set via one, two or more stages (steps). Embodiments of the invention create this change in pressure by increasing a pressure force exerted on the paper to be conveyed by, e.g., rollers or belt elements of the conveyor 164. Other embodiments employ suction belts, the pressure in this case being set by varying the suction force applied.

Further embodiments employ conveyors wherein the conveyor elements, e.g. the rollers, are formed of metal, whose surface property may be changed in dependence on a current applied on account of electrostatic charging, so that, e.g., a low coefficient of friction is achieved when no current flows through the metal roller, and a high coefficient of friction is achieved when current flows through the metal roller. Other embodiments use conveyor elements whose surface property may be changed in that—in a situation wherein a low frictional force is desired—only metal portions of a roller or other portions having a low coefficient of friction are in contact with the papers to be transported. In a situation wherein a high frictional force is desired, said driving elements may be configured such that other areas of the roller which have a higher coefficient of friction may be “switched in”. Yet other embodiments of the invention use conveyors 164 wherein opposite pairs of rollers are used, at least one of the pairs of rollers being journaled such that either a first roller of the pair of rollers or a second roller of the pair of rollers is opposite a corresponding counter roller. Both rollers have different surface properties and, thus, different coefficients of friction. Depending on the frictional force desired, either a first roller is brought into contact with the paper web to be conveyed, or the second roller is brought into contact with the paper web to be conveyed. Alternatively, provision may also be made for both rollers to be made of the same material, but to be pressed against the paper web with different forces.

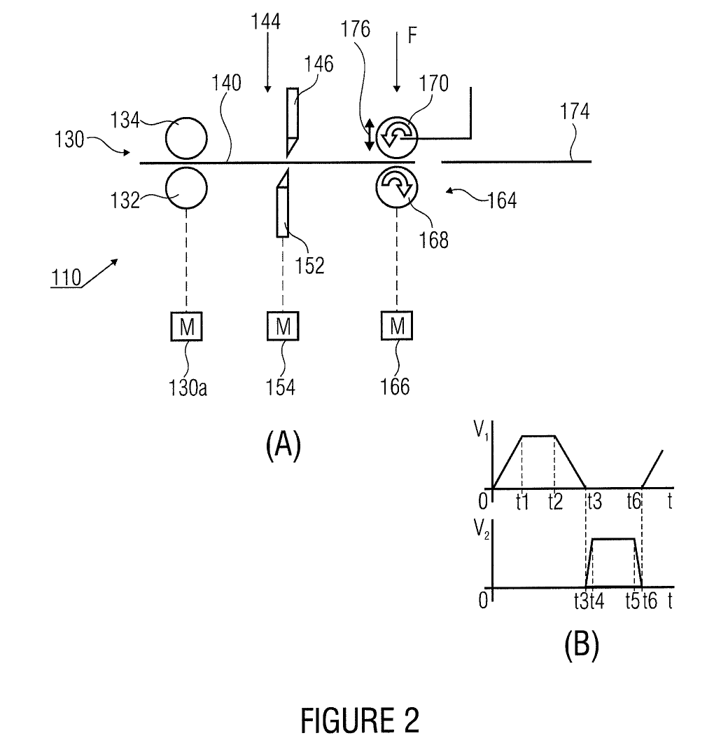

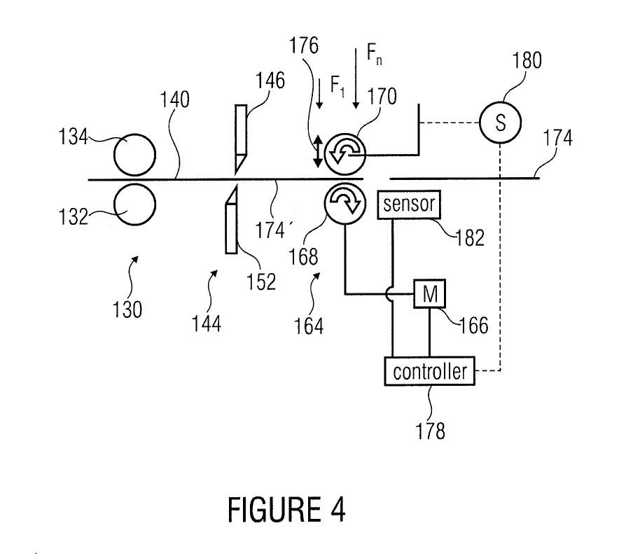

FIG. 4 shows a schematic representation of a device for transferring of sheets between two conveyors within a cutter in accordance with embodiments of the invention, whereby the above-described problems are avoided in that the frictional force is changed by changing the pressure exerted on the sheet. The arrangement of FIG. 4 is similar to the arrangement of FIG. 2, with an additional controller 178 being provided which is associated with the paper outlet 164 of the cutter. The controller 178 is operatively connected to the motor 166 as well as to a servo motor 180 and to a sensor 182. Via the servo drive 180, the upper roller 170 of the pair of rollers of the removal element 164 may be set such that a predetermined force F1 or Fn is exerted on a sheet located between the rollers 168 and 170. The sensor 182 recognizes when an individual sheet 174 has left the pair of rollers 168, 170. Moreover, the conveyor 164 is controlled, via the controller 178, such that its velocity follows the drive curve of the paper feed 130 of the cutter at low excess velocity or no excess velocity at all. In addition, the pressure may be varied by means of the servo drive 180 and the controller 178 and is switched in an optimum manner during the course of the process. The drive of the conveyor may be coupled to the drive 130 of the cutter via a mechanical or an electrical gear so as to follow the drive curve thereof. Alternatively, the corresponding matching drive curves may be stored for the drives and be triggered by a signal, it being possible for the corresponding drive curves or velocity profiles to be stored in corresponding controllers.

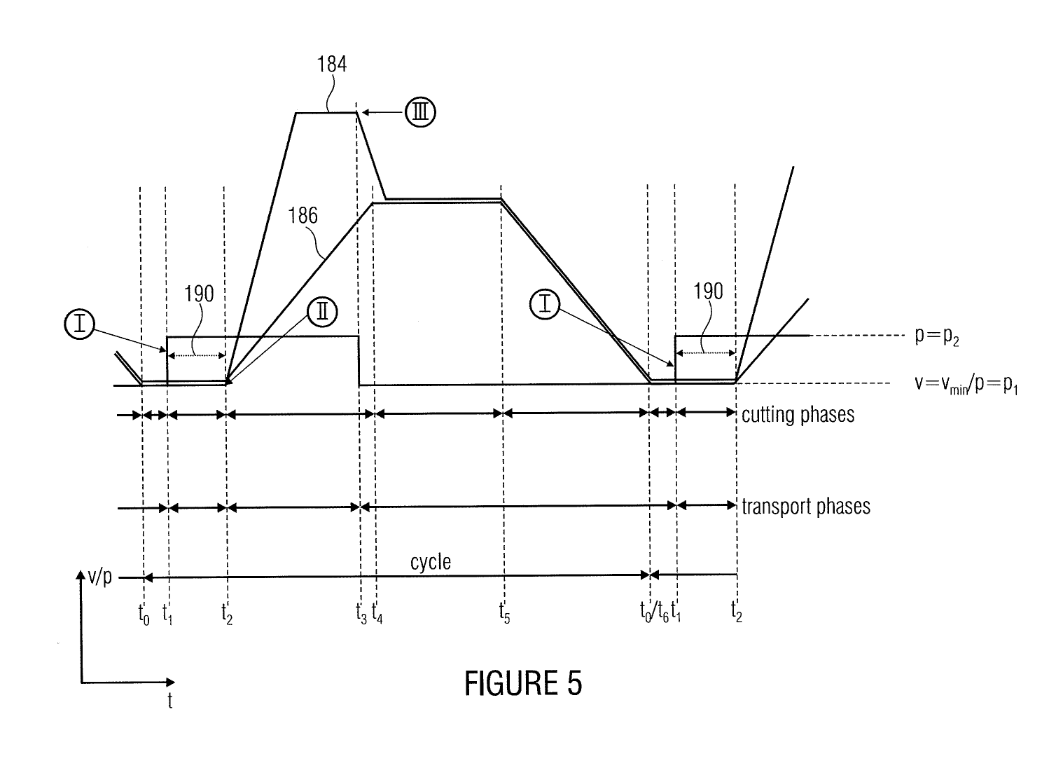

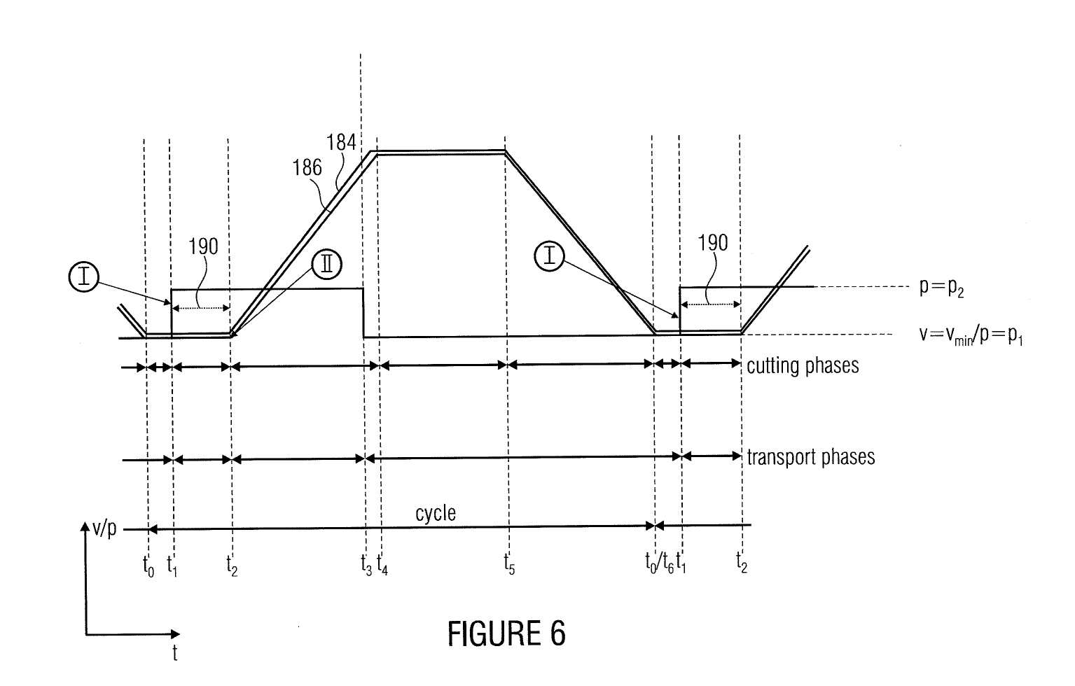

According to the above description, the second conveyor 164 is configured, in accordance with embodiments of the invention, such that it has a velocity which at least partially follows a drive curve of the first conveyor 130. This means, for example, that the second conveyor 164 corresponds to the velocity curve of the first conveyor over time (see FIG. 6 which will be described later on), the velocity of the second conveyor corresponding to the velocity of the first conveyor in each case, or the velocity of the second conveyor being increased by an essentially constant amount as compared to the velocity of the first conveyor in each case. Alternatively, the second conveyor 164 may only partially correspond to the velocity curve of the first conveyor over time (see FIG. 5, which will be described later on).

A processing cycle of the device shown in FIG. 4 will be described in more detail below with reference to FIG. 5 in accordance with embodiments of the invention. FIG. 5 has plotted therein, on the one hand, the velocity profile 185 of the removal 164, and, on the other hand, the velocity profile 186 of the feeding means 130 of the cutter. The time is plotted along the x direction, and the velocity, on the one hand, and the pressure exerted on a sheet by the rollers 168, 170, on the other hand, are plotted along the y direction, the curve 188 representing the pressure to which a sheet located between the rollers 168, 170 is exposed.

FIG. 5 shows a processing cycle of the arrangement of FIG. 4 which extends from a time t₀ to a time t₆ and repeats itself accordingly from the time t₆ onward. During the time duration between t₀ and t₁, the paper web 140 is positioned between the knives 146 and 152, so that the paper web 140 is cut during the subsequent cutting phase between the times t₁ and t₂. During the time duration between the time t₂ and the time t₃, a cut sheet 174 is located, at the point of entry, between the rollers 168, 170 of the conveyor 164, and is conveyed by said conveyor 164. During the time period from t₂ to t₄, the cutter accelerates the paper web 140 so as to move the paper web to being positioned between the knives 146, 152 for a further cut. The acceleration phase between the time t₂ and the time t₄ is followed by the constant phase of the cutter between the time t₄ and the time t₅, during which the paper web 140 is moved along in the direction of the knives 146, 152 at a constant velocity. The constant phase of the cutter is followed by the deceleration phase of the cutter between the times t₅ and t₆, during which the paper web 140 is decelerated. During the time duration between t₀ and t₁ as well as t₄ and t₆, the conveyor operates synchronously with the cutter at a low pressure, the pressure being increased at the time t₁.

The course of a cycle of the installation of FIG. 4 is such that during the cutting time 190 (time duration between t₁ and t₂), the pressure in the conveyor 164 is increased from the lower value p1 to the higher value p2, as is shown at the switching point I in FIG. 5. As soon as the cut has been made, the conveyor 164 removes the sheet 174 in a slipless manner, as is shown at the switching point II. In the embodiment shown in FIG. 5, the velocity and acceleration at which the conveyor 164 operates are higher than the velocity and acceleration at which the paper feed 130 of the cutter operates, so that a distance arises between the removed sheet 174 and the newly advanced sheet 174′ (see FIG. 4). This is illustrated by the different degrees of steepness of the edges of the velocity profiles 184 and 186 in the time duration between t₂ and t₃. As soon as the sheet 174 has left the conveyor 164, which is detected, for example, by the sensor 182, the drive of the transport is switched back from the higher velocity to a velocity that is slightly higher than the advance velocity of the cutting machine, as may be seen at the switching point III. In this manner, the paper, or the paper web 140, may be pulled tight for the next cut. At the same time, the pressure of the conveyor 164 is greatly reduced at the switching point III (time t₃), for example from the elevated pressure value p2 to the low pressure value p1, so that interference with the advancement of the cutting machine when positioning the paper under the knife 146, 152 is prevented, but the paper 140 can be pulled tight all the same. Due to the low pressure and the low excess velocity (and the resulting low difference in velocity between the conveyor 164 and the paper) in this phase (between t₀ and t₁ as well as t₃ and t₆) it is ensured, in addition, that very little frictional energy is caused by slip. Actually, the resulting frictional heat at this point is so low that the imprint on the paper web, or the imprint on the sheet 174 held between the transport rollers 168, 170 cannot be damaged. As may be seen in FIG. 5, the drive of the conveyor 164 follows the advance drive 130 of the cutter at a low excess velocity and at a low pressure until a standstill occurs (see time t₁), so that the next cut may be performed. Subsequently, the process starts again.

FIG. 6 shows a further embodiment of the invention, wherein, similarly to FIG. 5, the velocity curve of the rollers, or the course of the pressure exerted by the rollers of the conveyor 164, is recorded. Unlike the embodiment shown in FIG. 5, in the embodiment shown in FIG. 6, the conveyor 164 is driven at the same accelerations as the advancement 130, as is revealed by a comparison of sections t₂ and t₄ between FIGS. 5 and 6. Otherwise, the curve of FIG. 6 corresponds to the curve described by means of FIG. 5.

With regard to the embodiments described with reference to FIGS. 5 and 6, the above description states that the velocity and/or acceleration of the conveyor 164 is higher than the velocity/acceleration of the cutting machine. Alternatively, provision may be made, in other embodiments, for equalizing the velocity/acceleration of the conveyor 164 and the velocity/acceleration of the cutting machine.

In addition, it is to be noted that the velocities, described with reference to FIGS. 5 and 6, between the times t₁ and t₂ represent a velocity which is minimal as compared to one or all of the other sections, which either signify a velocity of zero, i.e. a standstill, or a velocity that is lower than the velocity in any of the preceding sections.

The embodiments described relate to a cutter and were illustrated by means of a cutter which singulates paper webs printed upon in a one-up manner. However, the principles of the invention may similarly be applied to cutters singulating such paper webs into individual sheets that have been printed on in a two-up or multi-up manner, the various partial webs resulting from the longitudinal cut each having an associated conveyor corresponding to the conveyor 164 in FIG. 4, whose velocity and pressure are coordinated with the advancement of the cutter in the above-described manner.

Embodiments of the cutters were described above with reference to an installation in accordance with FIG. 1. It shall be pointed out that in accordance with embodiments of the invention, the cutters may also be used in other installations. For example, a cutter may be located upstream from a stacker and may receive, from a printer or a continuous drum, a pre-printed or non-pre-printed paper web and cut it into individual sheets that are then fed to the stacker so as to create stacks of individual sheets. Such a stack may then be removed and provided for further processing. This stack may be supplied to a printer, for example, or to an insert/supplement adding device or a paper handling installation.

In the above-described embodiments, cutters were contemplated that operate in a start-stop operation. Instead of cutters, other components may also be operated in accordance with the principles of the invention, for example tearing machines or punching machines. Likewise, embodiments of the invention may be applied for transferals, in particular dragging transferals, wherein the paper is discharged faster, e.g. for transferals from a first conveyor to a second conveyor within a paper handling installation (e.g. between modules/stations of the installation) and/or within a module/a station of a paper handling installation.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A method of transporting printed paper within a paper handling installation from a first conveyor to a second conveyor, wherein the second conveyor comprises a velocity which at least partially follows a drive curve of the first conveyor when the paper is conveyed by the first conveyor and the second conveyor,
the method comprising:
conveying the paper by the first conveyor in the direction of the second conveyor;
once the paper has reached the second conveyor, conveying the paper by the first conveyor and the second conveyor, wherein a frictional force between the second conveyor and the paper is set to a first value;
processing the paper; and
conveying the processed paper by the second conveyor, wherein the frictional force between the second conveyor and the paper is set to a second value, which is higher than the first value.

2. The method as claimed in claim 1, wherein the frictional force is reset to the first value when the paper is no longer conveyed by the second conveyor, so that further paper is initially conveyed by the second conveyor at a lower frictional force.

3. The method as claimed in claim 1, wherein the frictional force between the second conveyor and the paper is increased from the first value to the second value in a step-by-step or continuous manner.

4. The method as claimed in claim 1, wherein the first value and the second value of the frictional force are set in dependence on one or several properties of the paper and/or in dependence on the velocity at which the paper is conveyed.

5. The method as claimed in claim 1, wherein the first conveyor conveys the paper during a first section of a processing cycle at a velocity, which is reduced as compared to a velocity during a different section of the processing cycle, the first conveyor moving the paper at a predetermined velocity profile, the method comprising:
(a) driving the second conveyor at a velocity profile which follows the velocity profile of the first conveyor;
(b) setting the frictional force to the second value upon achieving a first time during the first section of the processing cycle;
(c) conveying the paper by means of the second conveyor at the frictional force set to the second value; and
(d) once the paper has left the second conveyor, setting the frictional force to the first value, so that further paper has a lower frictional force applied to it by the second conveyor.

6. The method as claimed in claim 5, comprising:
(e) repeating (b) to (d).

7. The method as claimed in claim 5, wherein a velocity of the second conveyor for the matching sections of the velocity profiles of the first conveyor and of the second conveyor is higher than a velocity at which the first conveyor conveys the paper.

8. The method as claimed in claim 5, wherein the velocity profile of the second conveyor between the time when the paper has left the second conveyor and the end of the processing cycle follows the velocity profile of the first conveyor, and wherein the velocity profile of the second conveyor between the end of the first section of the processing cycle and the time when the paper has left the second conveyor is such that the second conveyor conveys the paper faster than the first conveyor.

9. The method as claimed in claim 1, wherein the frictional force between the second conveyor and the paper is set by changing a surface property of an element of the second conveyor that is in contact with the paper.

10. The method as claimed in claim 1, wherein the frictional force between the second conveyor and the paper is set by changing a pressure exerted on the paper by the second conveyor.

11. The method as claimed in claim 1, wherein the second conveyor comprises a suction belt, the frictional force between the second conveyor and the paper being set by changing the suction force applied that is exerted on the paper by the second conveyor.

12. The method as claimed in claim 1, wherein a drive of the first conveyor and a drive of the second conveyor are coupled, so that the second conveyor follows the drive curve of the first conveyor.

13. The method as claimed in claim 1, wherein a controller stores the drive curve of a drive of the first conveyor.

14. The method as claimed in claim 1, wherein the first conveyor operates in a start-stop operation, the paper being stopped, for processing, by stopping the first conveyor while the second conveyor continues to be driven.

15. The method as claimed in claim 14, wherein the paper is present in the form of a paper web that is conveyed by the first conveyor,
wherein an individual sheet is created from the paper web when the paper web is being stopped,
wherein the second conveyor receives a front end of the paper web prior to creating the individual sheet and conveys the paper web prior to and during the creation of the individual sheet, and
wherein the second conveyor removes the individual sheet.

16. The method as claimed in claim 15, wherein creating the individual sheet comprises cutting or tearing the paper web.

17. The method as claimed in claim 14, wherein the paper is present in the form of individual sheets,
wherein an individual sheet is processed when the individual sheet is being stopped,
wherein the second conveyor receives a front end of the individual sheet and conveys the individual sheet prior to and during processing, and
wherein the second conveyor removes the processed individual sheet.

18. The method as claimed in claim 1, wherein the first conveyor is part of a precursor component within the paper handling installation, and wherein the second conveyor is part of a follower component within the paper handling installation.

19. A paper handling installation comprising:
a first conveyor and a second conveyor, the second conveyor comprising a velocity which at least partially follows a drive curve of the first conveyor when the paper is conveyed by the first conveyor and the second conveyor;
a processor for processing the paper; and
a controller operatively connected to the first conveyor, the second conveyor and the processor for processing the paper so as to result in that
the paper is conveyed by the first conveyor in the direction of the second conveyor;
once the paper has reached the second conveyor, the paper is conveyed by the first conveyor and the second conveyor, a frictional force between the second conveyor and the paper being set to a first value;
the paper is processed by the processor; and
the processed paper is conveyed by the second conveyor, the frictional force between the second conveyor and the paper being set to a second value higher than the first value.

20. The paper handling installation as claimed in claim 19, wherein the controller is operative to reset the frictional force to the first value when the paper is no longer conveyed by the second conveyor, so that further paper is initially conveyed by the second conveyor at a lower frictional force.

21. The paper handling installation as claimed in claim 19, wherein the controller is operative to increase the frictional force between the second conveyor and the paper from the first value to the second value in a step-by-step or continuous manner.

22. The paper handling installation as claimed in claim 19, wherein the first value and the second value of the frictional force are set in dependence on one or several properties of the paper and/or in dependence on the velocity at which the paper is conveyed.

23. The paper handling installation as claimed in claim 19, wherein the first conveyor conveys the paper during a first section of a processing cycle at a velocity, which is reduced as compared to a velocity during a different section of the processing cycle, the first conveyor moving the paper at a predetermined velocity profile, the controller being operative to
drive the second conveyor at a velocity profile which follows the velocity profile of the first conveyor;
set the frictional force to the second value upon achieving a first time during the first section of the processing cycle;
convey the paper by means of the second conveyor at the frictional force set to the second value; and
once the paper has left the second conveyor, set the frictional force to the first value, so that further paper has a lower frictional force applied to it by the second conveyor.

24. The paper handling installation as claimed in claim 19, wherein the first conveyor is part of a precursor component within the paper handling installation, and wherein the second conveyor is part of a follower component within the paper handling installation.

25. The paper handling installation as claimed in claim 19, wherein the processor for processing the paper comprises a separator for separating a paper web into individual sheets,
wherein an individual sheet is created from the paper web when the paper web is being stopped,
wherein the second conveyor receives a front end of the paper web prior to creating the individual sheet and conveys the paper web prior to and during the creation of the individual sheet, and
wherein the second conveyor removes the individual sheet.

26. The paper handling installation as claimed in claim 19, wherein the processor for processing an individual sheet operates in a start-stop operation; and wherein the controller is operative to stop the paper, for processing, by stopping the first conveyor while the second conveyor continues to be driven.
